(19) United States
(12) Patent Application Publication
(10) Pub. No.: US 2026/0235439 A1
(43) Pub. Date: Aug. 13, 2026

(54) DUAL-COMB SPECTROSCOPY SYSTEM WITH TUNABLE FREQUENCY DIFFERENCE AT HIGH REPETITION RATES

(71) Applicant: SOUTH CHINA UNIVERSITY OF TECHNOLOGY, Guangzhou (CN)

(72) Inventors: Xiaoming WEI, Guangzhou (CN); Lin LING, Guangzhou (CN); Wenlong WANG, Guangzhou (CN); Zhongmin YANG, Guangzhou (CN)

(73) Assignee: SOUTH CHINA UNIVERSITY OF TECHNOLOGY, Guangzhou (CN)

(21) Appl. No.: 19/160,043

(22) PCT Filed: Mar. 31, 2023
(86) PCT No.: PCT/CN2023/085726

§ 371 Date: Aug. 27, 2025

(30) Foreign Application Priority Data
Feb. 27, 2023 (CN) 202310170847.3

(51) Int. Cl. G01J 3/02; G01B 9/02; G01B 9/02001; G01B 9/02003; G01J 3/10; G01J 3/26

(52) U.S. Cl. CPC G01J 3/0237; G01B 9/02003; G01B 9/02008; G01B 9/02084; G01J 3/0208; G01J 3/0218; G01J 3/0229; G01J 3/26; G01J 2003/104

(57) ABSTRACT

Disclose is a dual-comb spectroscopy system with tunable frequency difference at high repetition rates, including a signal optical comb, a local oscillator optical comb, a first beam splitter, a second beam splitter, a sample under test, a mirror, a photodetector, and a signal processing and analyzing module.

### TECHNICAL FIELD

The present invention pertains to a field of optical frequency comb technology, and specifically relates to a dual-comb spectroscopy system with tunable frequency difference at high repetition rates.

### BACKGROUND

An optical frequency comb, as a novel stable frequency measurement tool, has greatly advanced the field of precision science since invention, being widely applied in optical frequency measurement, absolute distance measurement, molecular absorption spectroscopy, astronomical spectral calibration, optical atomic clocks, optical communication, and optical arbitrary waveform synthesis.

A dual-comb spectroscopy system is formed by multi-longitudinal-mode heterodyne interference between two optical frequency combs with slightly different repetition rates but overlapping spectral ranges (Coddington I, Newbury N, Swann W. Dual-comb spectroscopy[J]. Optica, 2016, 3(4): 414-426.). Rapid optical heterodyne detection is achieved using dual-comb spectroscopy technology, offering high sensitivity, high resolution, and high accuracy. As compared with conventional optical measurement methods through which optical frequency components are directly detected, the optical frequency components are down-converted to radio frequency region using dual-comb spectroscopy technology and detected directly by a photodetector, and an actual optical frequency signal is then reconstructed through data processing, significantly reducing dependence on detector bandwidth. The use of dual-comb spectroscopy technology avoids mechanical scanning in the system, resulting in a measurement system structure that is more compact, practical, and stable, expanding application scenarios and usage range.

In the dual-comb spectroscopy system, the repetition rate difference between two optical frequency combs determines the conversion factor for down-converting the optical frequency of the dual-comb spectroscopy system to the radio frequency region, corresponding to the magnification factor of periodic temporal information, directly affecting the accuracy and resolution of the dual-comb spectroscopy system. Higher accuracy and resolution are not always preferable, as they increase the difficulty of data collection, analysis, and processing, placing higher demands on the processing system. Different samples under test have varying requirements for the repetition rate difference between the dual optical frequency combs. To make the dual-comb spectroscopy system adaptable to a wider range of measurement samples and meet the needs of different scenarios and applications, achieving a tunable repetition rate difference of the dual-comb spectroscopy system is crucial.

### SUMMARY

To overcome the shortcomings of the existing technology, an objective of the present invention is to provide a dual-comb spectroscopy system with tunable frequency difference at high repetition rates, where an output pulse repetition rate of one optical frequency comb is changed while an output pulse repetition rate of the other optical frequency comb remains fixed, achieving a dual-comb spectroscopy system with a tunable frequency difference through beating, enabling flexible adjustment of sensitivity, accuracy, and resolution of the dual-comb spectroscopy system, and making the dual-comb spectroscopy system adaptable to a wider range of measurement samples.

The present invention is achieved through at least one of the following technical solutions.

A dual-comb spectroscopy system with tunable frequency difference at high repetition rates is provided, including a signal optical comb, a local oscillator optical comb, a first beam splitter, a second beam splitter, a sample under test, a mirror, a photodetector, and a signal processing and analyzing module.

The signal optical comb is connected to the first beam splitter, the sample under test is located between the first beam splitter and the mirror, the local oscillator optical comb is connected to the second beam splitter, the signal optical comb enables generated signal light to interact with the sample under test, carries sample information in an optical frequency signal reflected back by the mirror, the optical frequency signal passes through the first beam splitter and the second beam splitter, local oscillator light emitted by the local oscillator optical comb and the signal light carrying the sample information undergo down-conversion through beating at the second beam splitter to obtain a radio frequency signal, the signal is captured by the photodetector connected to the second beam splitter, and spectral information of the sample under test is restored by performing Fourier transform on the measured signal using the signal processing and analyzing module connected to the photodetector.

Further, an output pulse repetition rate of the signal optical comb is tunable, an output pulse repetition rate of the local oscillator optical comb remains fixed, and the tunable frequency difference of the dual-comb spectroscopy system is achieved by changing the repetition rate of the signal optical comb.

Further, the signal optical comb and the local oscillator optical comb are both high-repetition-rate mode-locked fiber lasers with locked repetition rates and carrier envelope phase offset frequencies, the signal optical comb includes a first wavelength division multiplexer, a first pump source, a first optical isolator, and a first resonant cavity, and the local oscillator optical comb includes a second wavelength division multiplexer, a second pump source, a second optical isolator, and a second resonant cavity.

The first pump source is connected to the first resonant cavity via the first wavelength division multiplexer, the first wavelength division multiplexer is configured to couple pump light generated by the first pump source into the first resonant cavity and output generated signal light out of the first resonant cavity, the first optical isolator is connected to the first wavelength division multiplexer, the second pump source is connected to the second resonant cavity via the second wavelength division multiplexer, the second wavelength division multiplexer is configured to couple pump light generated by the second pump source into the second resonant cavity and output generated signal light out of the second resonant cavity, and the second optical isolator is connected to the second wavelength division multiplexer.

Further, a first resonant cavity of the signal optical comb includes a first gradient index lens, a second gradient index lens, a first ferrule, a sleeve, a first gain fiber, a first semiconductor saturable absorber mirror, and a first dielectric film.

The first semiconductor saturable absorber mirror is disposed on a surface of one end of the first gradient index lens, the other end of the first gradient index lens is spacedly connected to one end of the second gradient index lens via the sleeve, the other end of the second gradient index lens is connected to one end of the first ferrule, the first dielectric film is disposed on a surface of the other end of the first ferrule, the first dielectric film is connected to the first wavelength division multiplexer of the signal optical comb, and the first gain fiber is located inside the first ferrule.

Further, a second resonant cavity of the local oscillator optical comb includes a second ferrule, a second gain fiber, a second semiconductor saturable absorber mirror, and a second dielectric film.

The second semiconductor saturable absorber mirror is disposed on one end surface of the second ferrule, the second dielectric film is disposed on the other end surface of the second ferrule, the second dielectric film is connected to the second wavelength division multiplexer of the local oscillator optical comb, and the second gain fiber is located inside the second ferrule.

Further, transmission between the first gradient index lens and the second gradient index lens is parallel light transmission, where a distance Li between the first gradient index lens and the second gradient index lens is adjusted, without affecting the propagation trajectory of parallel light therebetween, enabling adjustment of a total cavity length L of the first resonant cavity of the signal optical comb, thereby changing an output pulse repetition rate of the signal optical comb.

Further, structures of the first resonant cavity and the second resonant cavity are both Fabry-Perot cavities.

Further, reflectivities of both the first dielectric film and the second dielectric film for generated laser light are greater than 60%.

Further, modulation depths of both the first semiconductor saturable absorber mirror and the second semiconductor saturable absorber mirror are from 1% to 10%.

Further, both the first gain fiber and the second gain fiber are fibers doped with rare earth ions, where the rare earth ions for doping include one or more types of erbium, ytterbium, thulium, and holmium.

Compared with the existing technology, the present invention has the following beneficial effects:

The present invention provides a dual-comb spectroscopy system with tunable frequency difference at high repetition rates, where an output pulse repetition rate of the signal optical comb is changed while an output pulse repetition rate of the local oscillator optical comb remains fixed, achieving the tunable frequency difference of the dual-comb spectroscopy system at high repetition rates, enabling adjustment of sensitivity, accuracy, and resolution of the dual-comb spectroscopy system, and making the dual-comb spectroscopy system adaptable to a wider range of measurement samples.

### BRIEF DESCRIPTION OF DRAWINGS

To more clearly illustrate technical solutions of embodiments of the present invention, drawings used in the embodiments are briefly introduced below. It should be understood that the drawings below only illustrate certain embodiments of the present invention and should not be considered as limiting the scope. For those skilled in the art, other related drawings can be obtained based on these drawings without creative effort.

FIG. 1 is a principal diagram of a dual-comb spectroscopy system with tunable frequency difference at high repetition rates according to an embodiment of the present invention.

FIG. 2 is a schematic structural diagram of a high-repetition-rate passive mode-locked fiber laser according to an embodiment of the present invention.

FIG. 3 is a schematic structural diagram of a first resonant cavity with a tunable repetition rate of a signal optical comb according to an embodiment of the present invention.

FIG. 4 is a schematic structural diagram of a second resonant cavity with a fixed repetition rate of a local oscillator optical comb according to an embodiment of the present invention.

Wherein:
1. signal optical comb; 2. local oscillator optical comb; 3. first beam splitter; 4. second beam splitter; 5. sample under test; 6. mirror; 7. photodetector; 8. signal processing and analyzing module; 9. first resonant cavity; 10. first wavelength division multiplexer; 11. first pump source; 12. first optical isolator; 13. first semiconductor saturable absorber mirror; 14. first gradient index lens; 15. sleeve; 16. second gradient index lens; 17. first gain fiber; 18. first ferrule; 19. first dielectric film; 20. second semiconductor saturable absorber mirror; 21. second gain fiber; 22. second ferrule; and 23. second dielectric film.

### DETAILED DESCRIPTION OF EMBODIMENTS

Technical solutions in embodiments of the present invention are described clearly and completely below with reference to the drawings in the embodiments of the present invention. The described embodiments are only some of the embodiments of the present invention, not all embodiments. Based on the embodiments in the present invention, all other embodiments obtained by those skilled in the art without creative effort fall within the scope of protection of the present invention.

To make the objectives, features, and advantages of the present invention more apparent and understandable, technical solutions of the present invention are further described in detail below with reference to the drawings and specific implementation examples. It should be noted that the specific embodiments described here are only used to explain the present invention and are not used to limit the present invention.

### Embodiment 1

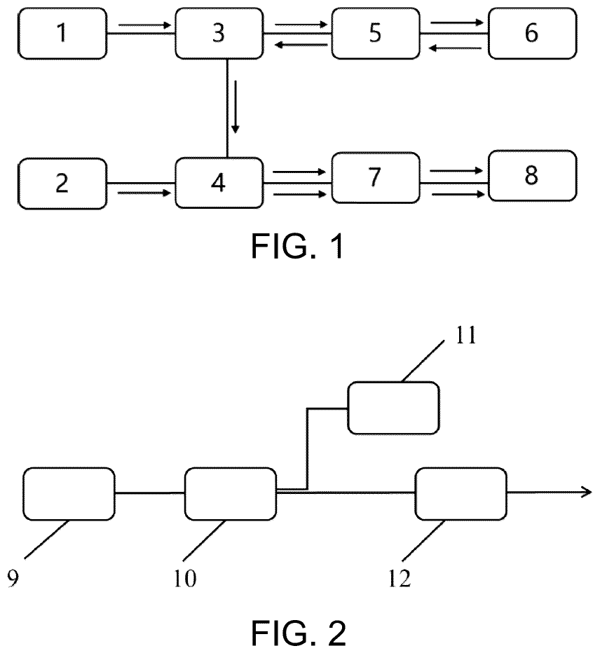

As shown in FIG. 1, this embodiment provides a dual-comb spectroscopy system with tunable frequency difference at high repetition rates, including a signal optical comb 1, a local oscillator optical comb 2, a first beam splitter 3, a second beam splitter 4, a sample under test 5, a mirror 6, a photodetector 7, and a signal processing and analyzing module 8. The signal optical comb 1 is connected to the first beam splitter 3, the sample under test 5 is located between the first beam splitter 3 and the mirror 6, and the local oscillator optical comb 2 is connected to the second beam splitter 4. The signal optical comb 1 is connected to the first beam splitter 3, enables generated signal light to interact with the sample under test 5 located between the first beam splitter 3 and the mirror 6, and carries sample information in an optical frequency signal reflected back by the mirror 6. The optical frequency signal passes through the first beam splitter 3 and the second beam splitter 4 connected to the local oscillator optical comb 2. Local oscillator light emitted by the local oscillator optical comb 2 and the signal light carrying the sample information undergo down-conversion through beating at the second beam splitter 4 to obtain a radio frequency signal. The signal is captured by the photodetector 7 connected to the second beam splitter 4, and spectral information of the sample under test is restored by performing Fourier transform on the measured signal using the signal processing and analyzing module 8 connected to the photodetector 7.

An output pulse repetition rate of the signal optical comb 1 is tunable, an output pulse repetition rate of the local oscillator optical comb 2 remains fixed, and the tunable frequency difference of the dual-comb spectroscopy system is achieved by changing the repetition rate of the signal optical comb 1.

As shown in FIG. 2, the signal optical comb 1 and the local oscillator optical comb 2 are both high-repetition-rate mode-locked fiber lasers with locked repetition rates and carrier envelope phase offset frequencies, the signal optical comb 1 includes a first wavelength division multiplexer 10, a first pump source 11, a first optical isolator 12, and a first resonant cavity 9, and the local oscillator optical comb 2 includes a second wavelength division multiplexer, a second pump source, a second optical isolator, and a second resonant cavity.

The first pump source 11 is connected to the first resonant cavity 9 via the first wavelength division multiplexer 10, the first wavelength division multiplexer 10 is configured to couple pump light generated by the first pump source 11 into the first resonant cavity 9 and output generated signal light out of the first resonant cavity 9, and the first optical isolator 12 is connected to the first wavelength division multiplexer 10. The second pump source is connected to the second resonant cavity via the second wavelength division multiplexer, the second wavelength division multiplexer is configured to couple pump light generated by the second pump source into the second resonant cavity and output generated signal light out of the second resonant cavity, and the second optical isolator is connected to the second wavelength division multiplexer. The first optical isolator 12 and the second optical isolator are configured to prevent return light from affecting the high-repetition-rate mode-locked pulse output.

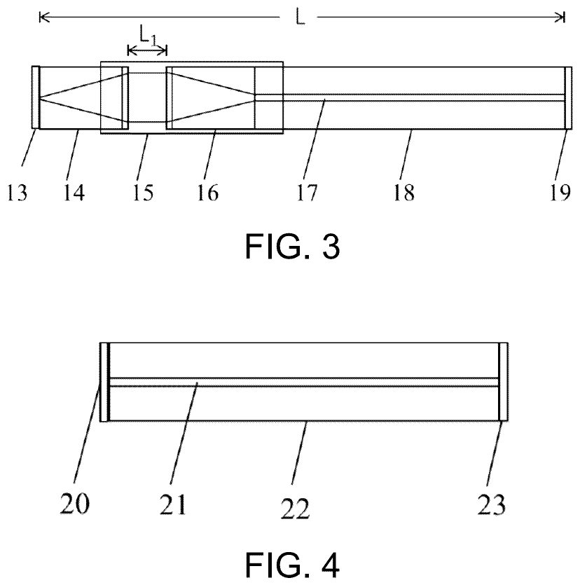

As shown in FIG. 3, a first resonant cavity 9 of the signal optical comb 1 includes a first gradient index lens 14, a second gradient index lens 16, a first ferrule 18, a sleeve 15, a first gain fiber 17, a first semiconductor saturable absorber mirror 13, and a first dielectric film 19. The first semiconductor saturable absorber mirror 13 is disposed on a surface of one end of the first gradient index lens 14, the other end of the first gradient index lens 14 is spacedly connected to one end of the second gradient index lens 16 via the sleeve 15, the other end of the second gradient index lens 16 is connected to one end of the first ferrule 18, the first dielectric film 19 is disposed on a surface of the other end of the first ferrule 18, the first dielectric film 19 is connected to the first wavelength division multiplexer 10, the first dielectric film 19 is connected to the first wavelength division multiplexer 10 of the signal optical comb 1, and the first gain fiber 17 is located inside the first ferrule 18.

Transmission between the first gradient index lens 14 and the second gradient index lens 16 is parallel light transmission, where a distance Li between the first gradient index lens 14 and the second gradient index lens 16 is adjusted, without affecting the propagation trajectory of parallel light therebetween, enabling adjustment of a total cavity length L of the first resonant cavity 9 of the signal optical comb 1, thereby changing an output pulse repetition rate of the signal optical comb 1.

As shown in FIG. 4, a second resonant cavity of the local oscillator optical comb 2 includes a second ferrule 22, a second gain fiber 21, a second semiconductor saturable absorber mirror 20, and a second dielectric film 23. The second semiconductor saturable absorber mirror 20 is disposed on one end surface of the second ferrule 22, the second dielectric film 23 is disposed on the other end surface of the second ferrule 22, the second dielectric film 23 is connected to the second wavelength division multiplexer 10 of the local oscillator optical comb 2, and the second gain fiber 21 is located inside the second ferrule 22.

In practical applications, the first resonant cavity 9 of the signal optical comb 1 is a Fabry-Perot cavity structure, with a total structural length of less than 10 cm, enabling high-repetition-rate mode-locked pulse output greater than 1 GHz, and achieving repetition rate adjustments on the order of MHz or even GHz.

The second resonant cavity of the local oscillator optical comb 2 is also a Fabry-Perot cavity structure, with an output pulse repetition rate different from but close to that of the signal optical comb.

The first pump source 11 and the second pump source are both semiconductor single-mode lasers, with a central wavelength of 974 nm and a maximum pump power of 460 mW.

The first dielectric film 19 and the second dielectric film 23 are both dichroic dielectric films applied one end surface of the ferrule by plasma sputtering, with a film system thickness of 14 μm, a reflection central wavelength of 1064 nm, a reflection bandwidth of 1010 nm-1080 nm, a reflectivity greater than 80%, a transmission central wavelength of 976 nm, and a transmissivity greater than 85%.

The first semiconductor saturable absorber mirror 13 and the second semiconductor saturable absorber mirror 20 have a central wavelength of 1040 nm, a reflection bandwidth of 1020 nm-1100 nm, an area of 1×1 mm, a thickness of 450 μm, a non-saturated absorption of 8%, a modulation depth of 5%, a non-saturated loss of 3%, a saturation flux of 40 μJ/cm2 , a relaxation time of 1 ps, and a damage threshold of 3 mJ/cm2.

The first gain fiber 17 in the first resonant cavity 9 of the signal optical comb 1 is a 7-cm-long fiber doped with rare earth ions, that is, ytterbium ions, and the second gain fiber 21 in the second resonant cavity of the local oscillator optical comb 2 is an 8-cm-long fiber doped with rare earth ions, that is, ytterbium ions, with a core diameter and a cladding diameter of 4 μm and 125 μm, respectively. After it is fixed in the ferrule using epoxy resin, both ends of the ferrule need to be vertically polished.

The ferrule is a ceramic ferrule, with an inner diameter of 125 μm matching the cladding diameter of the gain fiber, and an outer diameter of 2.5 mm, equal to the outer diameters of the first gradient index lens 14 and the second gradient index lens 16.

The sleeve 15 is a ceramic sleeve, with an inner diameter of 2.5 mm, matching the outer diameters of the ferrule, the first gradient index lens 14, and the second gradient index lens 18.

### Embodiment 2

As shown in FIG. 1, a dual-comb spectroscopy system with tunable frequency difference at high repetition rates provided in this embodiment has the same structure as that in Embodiment 1, but parameters of materials such as the gain fiber, dispersion film, and semiconductor saturable absorber mirror in the resonant cavity differ, resulting in different central spectra, repetition rates, and repetition rate differences for the dual-comb spectroscopy systems with tunable frequency difference.

The first dielectric film 19 and the second dielectric film 23 are both dichroic dielectric films applied to one end surface of the ferrule by plasma sputtering, with a film system thickness of 15 μm, a reflection central wavelength of 1550 nm, a reflection bandwidth of 1480 nm-1700 nm, a reflectivity greater than 85%, a transmission central wavelength of 976 nm, and a transmissivity greater than 85%.

The first semiconductor saturable absorber mirror 13 and the second semiconductor saturable absorber mirror 20 have a central wavelength of 1550 nm, a reflection bandwidth of 1450 nm-1580 nm, an area of 1×1 mm, a thickness of 450 μm, a non-saturated absorption of 7%, a modulation depth of 3%, a non-saturated loss of 4%, a saturation flux of 15 μJ/cm2 , a relaxation time of 10 ps, and a damage threshold of 800 μJ/cm2 .

The first gain fiber 17 in the first resonant cavity 9 of the signal optical comb 1 is a 7.5-cm-long erbium-ytterbium co-doped phosphate fiber, and the second gain fiber 21 in the second resonant cavity of the local oscillator optical comb 2 is an 8.5-cm-long erbium-ytterbium co-doped phosphate fiber, with a core diameter and a cladding diameter of 6 μm and 125 μm, respectively.

### Embodiment 3

As shown in FIG. 1, a dual-comb spectroscopy system with tunable frequency difference at high repetition rates provided in this embodiment has the same structure as that in Embodiment 1, but parameters of materials such as the gain fiber, dispersion film, and semiconductor saturable absorber mirror in the resonant cavity differ, resulting in different central spectra, repetition rates, and repetition rate differences for the dual-comb spectroscopy systems with tunable frequency difference.

As shown in FIG. 3, when the first resonant cavity 9 and the second resonant cavity in this embodiment are used in a high-repetition-rate passive mode-locked fiber laser, the first pump source 11 and the second pump source used are single-mode semiconductor lasers with a wavelength of 1570 nm.

The first dielectric film 19 and the second dielectric film 23 are both dichroic dielectric films applied to one end surface of the ferrule by plasma sputtering, with a film system thickness of 17 μm, a reflection central wavelength of 1950 nm, a reflection bandwidth of 1850 nm-2050 nm, a reflectivity greater than 90%, a transmission central wavelength of 1570 nm, and a transmissivity greater than 95%.

The first semiconductor saturable absorber mirror 13 and the second semiconductor saturable absorber mirror 20 have a central wavelength of 2000 nm, a reflection bandwidth of 1890 nm-2060 nm, an area of 1&44 1 mm, a thickness of 450 μm, a non-saturated absorption of 20%, a modulation depth of 12%, a non-saturated loss of 8%, a saturation flux of 65 μJ/cm2, a relaxation time of 10 ps, and a damage threshold of 2 mJ/cm2.

The first gain fiber 17 in the first resonant cavity 9 of the signal optical comb 1 is a 7-centimeter-long thulium-doped silica fiber, and the second gain fiber 21 in the second resonant cavity of the local oscillator optical comb 2 is an 8.5-centimeter-long thulium-doped silica fiber, with a core diameter and a cladding diameter of 5 μm and 125 μm, respectively.

The embodiments in this specification are described in a progressive manner, each embodiment focuses on differences from other embodiments, and similar parts among the embodiments can be referred to each other.

The above embodiments of the present invention are merely examples to clearly illustrate the present invention and are not intended to limit the implementation of the present invention. For those skilled in the art, other different forms of changes or modifications can be made based on the above description. All implementations need not and cannot be exhaustively listed here. Any modifications, equivalent substitutions, and improvements made within the spirit and principles of the present invention should be included within the scope of protection of the claims of the present invention.

1. A dual-comb spectroscopy system with tunable frequency difference at high repetition rates, comprising: a signal optical comb, a local oscillator optical comb, a first beam splitter, a second beam splitter, a sample under test, a mirror, a photodetector, and a signal processing and analyzing module; wherein
the signal optical comb is connected to the first beam splitter, the sample under test is located between the first beam splitter and the mirror, the local oscillator optical comb is connected to the second beam splitter, the signal optical comb enables generated signal light to interact with the sample under test and carries sample information in an optical frequency signal reflected back by the mirror, the optical frequency signal passes through the first beam splitter and the second beam splitter, local oscillator light emitted by the local oscillator optical comb and the signal light carrying the sample information undergo down-conversion through beating at the second beam splitter to obtain a radio frequency signal, the signal is captured by the photodetector connected to the second beam splitter, and spectral information of the sample is restored by the signal processing and analyzing module connected to the photodetector.

2. The dual-comb spectroscopy system according to claim 1, wherein an output pulse repetition rate of the signal optical comb is tunable, an output pulse repetition rate of the local oscillator optical comb remains fixed, and the tunable frequency difference of the dual-comb spectroscopy system is achieved by changing the output pulse repetition rate of the signal optical comb.

3. The dual-comb spectroscopy system according to claim 1, wherein the signal optical comb and the local oscillator optical comb are both high-repetition-rate mode-locked fiber lasers with locked repetition rates and carrier envelope phase offset frequencies, the signal optical comb comprises a first wavelength division multiplexer, a first pump source, a first optical isolator, and a first resonant cavity, and the local oscillator optical comb comprises a second wavelength division multiplexer, a second pump source, a second optical isolator, and a second resonant cavity; wherein
the first pump source is connected to the first resonant cavity via the first wavelength division multiplexer, the first wavelength division multiplexer is configured to couple pump light generated by the first pump source into the first resonant cavity and output generated signal light out of the first resonant cavity, the first optical isolator is connected to the first wavelength division multiplexer, the second pump source is connected to the second resonant cavity via the second wavelength division multiplexer, the second wavelength division multiplexer is configured to couple pump light generated by the second pump source into the second resonant cavity and output generated signal light out of the second resonant cavity, and the second optical isolator is connected to the second wavelength division multiplexer.

4. The dual-comb spectroscopy system according to claim 1, wherein a first resonant cavity of the signal optical comb comprises a first gradient index lens, a second gradient index lens, a first ferrule, a sleeve, a first gain fiber, a first semiconductor saturable absorber mirror, and a first dielectric film; and
the first semiconductor saturable absorber mirror is disposed on a surface of one end of the first gradient index lens, an other end of the first gradient index lens is spacedly connected to one end of the second gradient index lens via the sleeve, an other end of the second gradient index lens is connected to one end of the first ferrule, the first dielectric film is disposed on a surface of an other end of the first ferrule, the first dielectric film is connected to the first wavelength division multiplexer of the signal optical comb, and the first gain fiber is located inside the first ferrule.

5. The dual-comb spectroscopy system according to claim 1, wherein a second resonant cavity of the local oscillator optical comb comprises a second ferrule, a second gain fiber, a second semiconductor saturable absorber mirror, and a second dielectric film; wherein
the second semiconductor saturable absorber mirror is disposed on one end surface of the second ferrule, the second dielectric film is disposed on an other end surface of the second ferrule, the second dielectric film is connected to the second wavelength division multiplexer of the local oscillator optical comb, and the second gain fiber is located inside the second ferrule.

6. The dual-comb spectroscopy system according to claim 4, wherein transmission between the first gradient index lens and the second gradient index lens is parallel light transmission, and a distance Li between the first gradient index lens 1 and the second gradient index lens is adjusted, to regulate a total cavity length L of the first resonant cavity of the signal optical comb, thereby changing an output pulse repetition rate of the signal optical comb.

7. The dual-comb spectroscopy system difference at high repetition rates according to claim 3, wherein structures of the first resonant cavity and the second resonant cavity are both Fabry-Perot cavities.

8. The dual-comb spectroscopy system according to claim 4, wherein reflectivities of both the first dielectric film and the second dielectric film for generated laser light are greater than 60%.

9. The dual-comb spectroscopy system according to claim 4, wherein modulation depths of both the first semiconductor saturable absorber mirror and the second semiconductor saturable absorber mirror are from 1% to 10%.

10. The dual-comb spectroscopy system according to claim 4, wherein both the first gain fiber and the second gain fiber are fibers doped with rare earth ions, and the rare earth ions for doping comprise one or more of types of erbium, ytterbium, thulium, and holmium.

11. The dual-comb spectroscopy system according to claim 5, wherein reflectivities of both the first dielectric film and the second dielectric film for generated laser light are greater than 60%.

12. The dual-comb spectroscopy system according to claim 5, wherein modulation depths of both the first semiconductor saturable absorber mirror and the second semiconductor saturable absorber mirror are from 1% to 10%.

13. The dual-comb spectroscopy system according to claim 5, wherein both the first gain fiber and the second gain fiber are fibers doped with rare earth ions, and the rare earth ions for doping comprise one or more of types of erbium, ytterbium, thulium, and holmium.
